(19) United States
(12) Patent Application Publication
(10) Pub. No.: US 2023/0343138 A1
(43) Pub. Date: Oct. 26, 2023

(54) COMBINED TRACKING METHOD FOR TARGET OBJECT

(71) Applicant: Aver Information Inc., New Taipei City (TW)

(72) Inventor: Hsin-Kuei Yeh, New Taipei City (TW)

(21) Appl. No.: 18/298,401

(22) Filed: Apr. 11, 2023

(30) Foreign Application Priority Data
Apr. 21, 2022 (TW) 111115200

(51) Int. Cl. G06V 40/16

(52) U.S. Cl. CPC G06V 40/174; G06V 40/161

(57) ABSTRACT

The present invention discloses a combined tracking method for a target object, which includes the following step 1 to step 3. The first step is to perform a face detection process to the humanoid target image to detect the human face target; the second step is to perform an expression analysis and recognition process to the human face target to obtain a target emotion; the third step is to perform a sound source tracking detection process to detect a target sound source when the target emotion is a preset emotion.

### CROSS REFERENCE TO RELATED APPLICATIONS

This Non-provisional application claims priority under 35 U.S.C. § 119(a) on Patent Application No. 111115200 filed in Taiwan on Apr. 21, 2022, the entire contents of which are hereby incorporated by reference.

### BACKGROUND

### 1. Technical Field

The invention relates to an object tracking method, in particular to a combined tracking method for the target object.

### 2. Description of Related Art

Due to the advancement of visual technology, many human-computer interaction mechanisms can be achieved by applying visual detection and identification technology. For example, a camera device is combined with image tracking technology and recognition technology to track the specific object or capture the image of the target object for output or recording.

In general, the image tracking technology is only for a specific target, and when the target has an unusual movement, it will be difficult to know the reason behind it only based on image tracking or image recognition. For example, in a teaching environment where a lecturer is teaching a group of listeners. At this time, a camera device can be used together with an image tracking algorithm to track the teaching process of the lecturer, and output or record images of the teaching process.

However, there may be many events during the teaching process that will affect the progress of teaching activities, for example, an emergency occurs near the teaching environment and the lecturer finds out and interrupts teaching, but the students or audience do not know why to stop teaching.

Consequently, it is an important subject of the invention to provide a combined tracking method for the target object so as to know the cause of the relay event (that is, the above-mentioned interruption of teaching) through different tracking methods.

### SUMMARY OF THE INVENTION

In view of the foregoing, an object of the invention is to provide a combined tracking method for a target object, which can track the specific object through the change of the feature of a target.

To achieve the above, the present invention provides a combined tracking method for the target object including the following steps. First is to perform a face detection process to a humanoid target image to detect a human face target; then is to perform an expression analysis and recognition process to the human face target to obtain a target emotion; final is to perform a sound source tracking detection process to detect a target sound source when the target emotion is a preset emotion.

In one aspect, the preset emotion includes at least one of anger, disgust, surprise, sadness, happiness, fear, or neutral emotion.

In one embodiment, the preset emotion is a negative emotion.

In one aspect, the combined tracking method for the target object further includes performing a human tracking and detection process on a first image to track a humanoid target, and capturing the humanoid target image after the humanoid target is detected.

In one aspect, after the target sound source is detected, the combined tracking method for the target object also includes capturing a second image for the direction where the target sound source is generated and outputting the second image to a display device.

In one aspect, the expression analysis and recognition process is calculated according to the expression of the human face target to obtain at least one expression feature value.

In one aspect, the target sound source is generated in a specific space and has a maximum volume.

In addition, to achieve the above, the present invention also provides a combined tracking method for a target object, which includes capturing a first image through an image detection and tracking process, and analyzing an expression feature in the first image and trigging a sound source tracking process to detect a target sound source after a preset emotion result is obtained.

As mentioned above, the combined tracking method for the target object of the invention utilizes two tracking technologies (i.e., image tracking and sound source tracking) together with emotion analysis and identification technology to obtain the cause of the emotional change of the relay target.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIG. 1 is a schematic illustration showing a tracking system cooperated with the combined tracking method for the target object according to a preferred embodiment of the invention.

FIG. 2 is a flowchart showing the combined tracking method for the target object according to the preferred embodiment of the invention.

### DETAILED DESCRIPTION

In the following description, this invention will be explained with reference to embodiments thereof. However, the description of these embodiments is only for purposes of illustration rather than limitation.

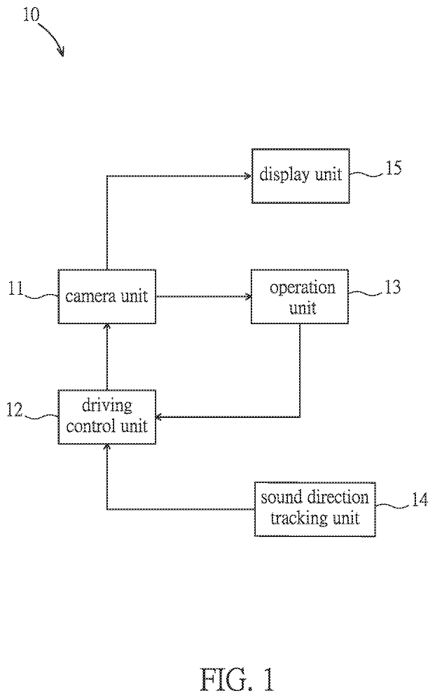

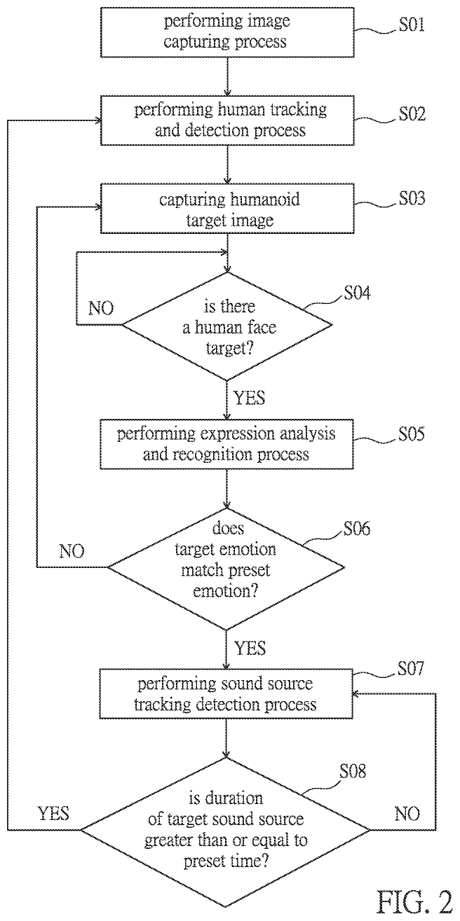

Referring to FIG. 1, a combined tracking method for the target object of the preferred embodiment is used with a tracking system 10, which includes a camera unit 11, a driving control unit 12, an operation unit 13, a sound direction tracking unit 14, and a display unit 15. In this embodiment, the tracking system 10 is installed in a classroom. In the classroom, there is a lecturer who is on a platform and gives lectures to the students. In addition, the camera unit 11 is, for example, a PTZ camera. Then, as shown in FIG. 2, the combined tracking method for the target object includes steps S01 to S08.

Step S01 is to perform an image capturing process by the camera unit 11, which can zoom out the focal length of the camera unit 11 to the wide-angle end to capture a larger range of images in the classroom, which is called the first image, which may include a series image frames with continuously or interval.

Step S02 is to perform a human tracking and detection process on the first image, which is to track the humanoid target when a human form appears in the frame of the first image. Further, the system can pre-set a tracking starting area such as the classroom door or a specific area of the platform. The tracking of the humanoid target is started when the lecturer opens the door and enters the classroom or moves to the center of the platform. Then, step S03 is performed.

Step S03 is to zoom in the camera unit 11 until it locks on the humanoid target for continuous tracking and to capture the humanoid target image. Here, the so-called “tracking” means that the driving control unit 12 may control the rotation angle, tilt angle, and focal length of the camera unit 11 so as to keep the humanoid target located in the image captured by the camera unit 11.

Step S04 is to perform a face detection process to the humanoid target image to determine whether there is a human face target in the image. Step S05 is performed if the human face target is detected and step S04 is re-performed if the human face target is not detected.

Step S05 is to zoom in the focal length of the camera unit 11 to the human face target and perform an expression analysis and recognition process to the human face target to obtain a target emotion. The expression analysis and recognition process may calculate the expression of the human face target through the operation unit 13 with deep learning to obtain at least one expression feature value or an expression feature value matrix, thereby obtaining a target emotion according to the expression feature value. Among them, the target emotion is, for example, anger, disgust, surprise, sadness, happiness, fear, or neutral emotions to represent the emotional response of the tracked target.

In this embodiment, the expression analysis and recognition process may input the image corresponding to the human face target into an artificial neural network model program to perform feature extraction, analysis, and generate classification results, that can use for example but not limited to convolution neural network (CNN), recurrent network (RNN), long short-term memory model (LSTM), attention mechanism (Attention), or generative adversarial network (GAN) for feature extraction and classification. More specifically, the artificial neural network model program generates a plurality of result data, wherein each result data has a probability characteristic value, and the result data with the highest probability characteristic value will be selected as the classification result and output.

Step S06 is to compare the target emotion with a preset emotion to determine whether the target emotion matches the preset emotion. Step S07 is performed if the target emotion matches the preset emotion and step S03 is re-performed if the target emotion does not match the preset emotion. In one of the scenarios of this embodiment, when some students are noisy and the lecturer is displeased and the teaching is interrupted, thus, the preset emotion is a negative emotion such as anger or disgust. In other embodiments, the preset emotion can also be set as a positive emotion of surprise or happiness if it is desired to track when the lecturer has a surprise or happy emotion when the students cheer the loudest. Since this embodiment is to track the displeasure of the lecturer caused by noisy students, the preset emotion can be set to anger.

Step S07 is to perform a sound source tracking detection process, which may use a sound direction tracking unit 14 to detect and track a target sound source with the highest volume in the classroom and perform step S08 after finding the target sound source.

Step S08 is to determine whether the duration of the target sound source is greater than or equal to a preset time. Step S07 is re-performed to re-track the target sound source if the result is “no” and step S02 is performed to continue the human tracking and detection process if the result is “yes”.

In step S07 of this embodiment, during the process of tracking the target sound source, the driving control unit 12 may be used to adjust the view-finding direction and focal length of the camera unit 11 at the same time so as to capture a second image in the direction of the target sound source, and the image of the target sound source (the second image) may be output to the display unit 15. In the operation scenario of this embodiment, when there are students making noise in the classroom and the lecturer has negative emotions, the image containing the students may be output to a display unit so as to monitor the teaching process or prevent the disturbance.

In addition, in step S08, the duration of the target sound source may be judged by the software counter. In addition to the detection result of the sound direction tracking unit 14, the fixed time of the camera unit 11 may also be used as a basis for judgment. Among them, the fixed motion system of the camera unit 11 may represent the orientation of the camera unit 11 continuously aiming at the target sound source.

Furthermore, the camera unit 11 of the tracking system 10 may be the camera unit with a single lens or the camera unit 11 with dual lenses. The camera unit 11 with dual lenses may track the human face target continuously while one lens is tracking the target sound source.

In summary, the combined tracking method for the target object of the invention utilizes image tracking and sound source tracking together with emotion analysis and identification technology to obtain the cause of the emotional change of the relay target. Through the combined tracking method for the target object, not only can a single target be tracked, but also the cause of the emotional change can be tracked according to the emotional change of the target.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

What is claimed is:

1. A combined tracking method for a target object, comprising:
performing a face detection process to a humanoid target image to detect a human face target;
performing an expression analysis and recognition process to the human face target to obtain a target emotion; and
performing a sound source tracking detection process to detect a target sound source when the target emotion is a preset emotion.

2. The combined tracking method of claim 1, wherein the preset emotion includes at least one of anger, disgust, surprise, sadness, happiness, fear, or neutral emotion.

3. The combined tracking method of claim 1, further comprising:
performing a human tracking and detection process on a first image to track a humanoid target; and
capturing the humanoid target image after the humanoid target is detected.

4. The combined tracking method of claim 1, wherein after the target sound source is detected, further comprising:
capturing a second image for the direction where the target sound source is generated; and
outputting the second image to a display device.

5. The combined tracking method of claim 1, wherein the expression analysis and recognition process being calculated according to the expression of the human face target to obtain at least one expression feature value.

6. The combined tracking method of claim 1, wherein the target sound source is generated in a specific space and has a maximum volume.

7. A combined tracking method for a target object, comprising:
capturing a first image through an image detection and tracking process; and
analyzing an expression feature in the first image and trigging a sound source tracking process to detect a target sound source after a preset emotion result is obtained.

8. The combined tracking method of claim 7, wherein after the target sound source is detected, further comprises capturing a second image for the direction where the target sound source is generated.

9. The combined tracking method of claim 7, wherein the target sound source is generated in a specific space and has a maximum volume.
